(19) United States
(12) Patent Application Publication
(10) Pub. No.: US 2008/0101845 A1
(43) Pub. Date: May 1, 2008

(54) Marker assembly

(76) Inventor: Alexander W. Fong, Schaumburg, IL (US)

Correspondence Address: Alexander W. Fong, 2678 College Hill Circle, Schaumburg, IL, 60173-5756, US

(21) Appl. No.: 11/982,468

(22) Filed: Oct. 31, 2007

Related U.S. Application Data
(60) Provisional application No. 60/855,674, filed on Oct. 31, 2006.

(51) Int. Cl. B05C 17/04

(52) U.S. Cl. 401/48; 101/123; 401/123; 401/139; 401/208

(57) ABSTRACT

A rolling marker assembly enables a user to mark serially-presented, repeating patterns upon a marking surface. The marker assembly comprises an outer casing and a marking caster assembly. The caster assembly comprises a marker carriage and a rotating pen assembly. The marker carriage comprises a casing attachment member and certain pen assembly-receiving structure. The pen assembly comprises an inner pen core, a plurality of ink-applying tiles, and a marker rotation axis. Each tile is adapted for receiving and applying ink. The pen assembly is rotatably received by the marker carriage via the pen assembly-receiving structure. The caster assembly is rotatably attached to the casing. The ink-applying tiles comprise raised patterns. The casing is manually traceable adjacent a marking surface such that the raised patterns are engageable upon the marking surface for applying ink thereto.

### PRIOR HISTORY

This application claims the benefit of U.S. Provisional Patent Application No. 60/855,674, filed in the United States Patent and Trademark Office on Oct. 31, 2006.

### FIELD OF THE INVENTION

The present invention generally relates to a certain writing implement or marking implement for generating serially-presented, repeating patterns upon a marking surface. More particularly, the present invention relates to a rolling marker assembly, method(s) achieved thereby, and a kit for enabling a user to construct selectively multi-colored patterns upon a marking surface.

### DESCRIPTION OF THE PRIOR ART

The state of the art relating to writing implements and/or other marking implements is well developed. A search into the state of the art reveals that a number of multi-colored marking implements are known in the prior art. Some of the more pertinent prior art relating to multi-colored marking implements and the like is briefly described, hereinafter.

U.S. Pat. No. 3,094,105 ('105 patent), which issued to Jenkins, discloses a Pen. The '105 patent teaches a writing device adapted to contain a plurality of separated fluids which are mixed upon discharge. The device comprises an elongated hollow body portion having opposite ends; certain removable closure means sealing one end of the body portion; a ball-mounting aperture formed in the opposite end of the body portion, a ball rotatably mounted in the aperture; and means disposed within the body portion providing at least two reservoirs, each reservoir being adapted to contain a different fluid and to maintain its fluid separated until the user draws or traces the ball against a marking surface, during which process the fluids are discharged from the reservoirs and mixed for marking a pattern upon the marking surface.

U.S. Pat. No. 3,705,774 ('774 patent), which issued to Kranich, discloses a Writing Instrument. The '774 patent teaches a ball point pen having a plurality of writing members, each containing a different colored ink. A writing member is selected by depressing a pressure member, inclining the instrument in a certain direction and then releasing the pressure member.

U.S. Pat. No. 4,692,046 ('046 patent), which issued to Lan, discloses a Pen with Selective Multi-Color Cores. The '046 patent teaches a pen containing multi-color cores located in different tubes housed in the pen body, which colors can be optionally selected for use readily using a specially-designed turnable knob having a projected edge in cam contact with the top end of the core-receiving tubes. The top end of the core-receiving tube is pushed downward for use, when the turnable knob is rotated, so to enable a person to select a color core as he wishes quickly and readily.

U.S. Pat. No. 5,352,282 ('282 patent), which issued to Miller, discloses Color Changing Compositions. The '282 patent teaches a multiple coloring composition system, the coloring effect of which is changed upon treatment with a second coloring composition, once the second coloring composition has been deposited over the first coloring composition. The multiple ink system comprises: (a) a first aqueous coloring composition comprising a first dye whose coloring ability is destroyed in the presence of a bleach; and (b) a second aqueous coloring composition comprising from about 1% to about 20% by weight of a bleach; and from about 0.1% to about 12% by weight of a colorant capable of maintaining its characteristic color in the presence of a bleach and/or a pH of about 10 or greater. The multiple coloring composition may further comprise a base in an amount sufficient to elevate the pH of the second aqueous coloring composition to a level of from about 10 to about 12.

U.S. Pat. No. 5,383,736 ('736 patent), which issued to Okulov, discloses a Writing Instrument with Plural Feeds. The '736 patent teaches a writing instrument including a body having at its distal end a saddle portion in which a writing element, for example a ball, is placed, and a feeding element with a plurality of channels through which mixing components may pass for application to a surface by the writing element. The feeding element is configured with the body so that the body is rotatable about the feeding element. There is provided at least one opening or passageway in the body position between the feeding element and the writing element wherein the mixing of the components takes place.

U.S. Pat. No. 6,056,463 ('463 patent), which issued to Nishio et al., discloses an Aqueous Ballpoint Pen Refill and Process for Producing the Same. The '463 patent teaches an aqueous ballpoint pen refill which can produce tasteful writings or drawings with a plurality of colors and which gives an attractive impression, since the inks in the ink reservoir constitute an interesting pattern and also a process for producing the same. A plurality of aqueous inks Ia and Ib with different colors are charged into an ink reservoir having a point tip at the front end to form a vertical or horizontal layered structure or a spiral structure; the aqueous inks containing pigments as coloring agents respectively and each having a viscosity of 45 mPa.multidot.S or more; the specific gravity difference of the inks being not more than 0.05. Injection needles connected respectively to front ends of a plurality of ink tanks are inserted to the transparent ink reservoir, and the plurality of inks with different colors are injected while the injection needles are drawn out of the ink reservoir.

### SUMMARY OF THE INVENTION

It is a primary object of the present invention to provide a rolling marker assembly for enabling a user to mark multi-colored, serially-presented, repeating patterns upon a marking surface. The rolling marker assembly summarily comprises a hand-holdable outer shell casing and a caster assembly. The outer shell casing comprises an inner casing surface, an outer casing surface, a substantially circular transverse casing cross-section, a longitudinal casing axis, a casing height, and a casing rim. The caster assembly comprises a marker carriage, a rotating pen assembly, and a caster assembly length.

The caster assembly comprises a marker carriage and a rotating pen assembly. The marker carriage comprises a casing attachment member and certain pen assembly-receiving means. The pen assembly comprises an inner pen core, a plurality of ink-applying tiles, and a marker rotation axis. Each ink-applying tile is adapted for receiving and applying ink.

The rotating pen assembly is rotatably received by the marker carriage via the pen assembly-receiving means, and the pen assembly is rotatable about the marker rotation axis. The caster assembly is rotatably attached to the casing, and thus is rotatable about the casing axis. Bearing in mind that the ink-applying tiles comprise raised patterns, the casing rim and the outer shell surfaces are manually traceable adjacent a marking surface such that the raised patterns are engageable upon the marking surface for applying ink thereto. The rolling marker assembly thus enables the user to mark serially-presented, repeating patterns upon the marking surface.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of patent drawings:

FIG. 1 is an exploded perspective view of an alternative marker assembly of the present invention.

FIG. 2 is an exploded perspective view of left and right roller halves and a plurality of pre-impregnated ink stamping strips of a cylinder assembly of the marker assembly of the present invention.

FIG. 3 is a perspective view of a cylinder assembly of the marker assembly of the present invention.

### DETAILED DESCRIPTION OF THE PREFERRED EMBODIMENT(S)

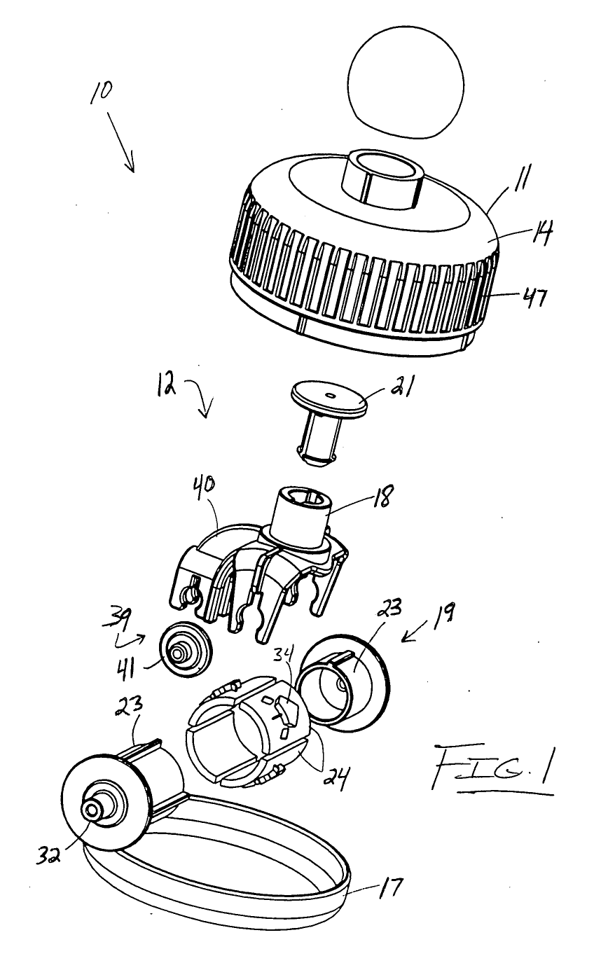

Referring now to the drawings, the preferred embodiment of the present invention concerns a rolling marker assembly 10 or rolling marker assembly as generally illustrated and referenced in FIG. 1. Rolling marker assembly 10 is designed to enable a user to mark serially-presented, repeating patterns upon a marking surface. The rolling marker assembly 10 comprises a hand-holdable casing 11 or outer marker shell and a caster type caster assembly 12 as generally referenced in FIG. 1.

Casing 11 preferably comprises a substantially circular transverse cross section as may be seen from a general inspection of the noted figure, and further inherently comprises an inner casing surface (not specifically depicted); an outer casing surface 14, a longitudinal casing axis, a casing height, and a casing rim 17 as generally referenced in FIG. 1. Casing 11 is sized and shaped to be received by a user's hand and is manipulatable by one's fingers and thumb.

Outer casing surface 14 may comprise certain means for enhancing ones grip upon rolling marker assembly 10, which gripping means may be defined by a textured outer casing surface 47 or similar other means for enhancing one's grip thereupon. Textured outer casing surface 47 thus enhances the user's ability to manually trace rolling marker assembly 10 adjacent a marking surface. The inner casing surface is preferably disposed in spaced (radial) adjacency to caster assembly 12 for enabling caster assembly 12 to rotate at least 360 rotational degrees about the casing axis.

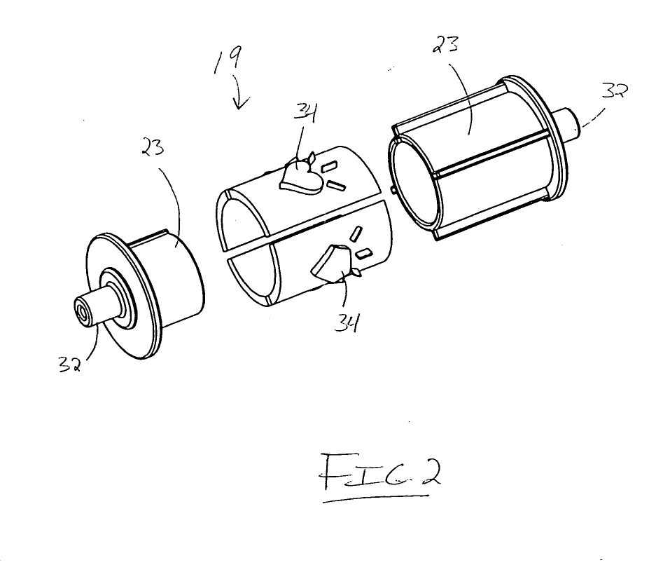

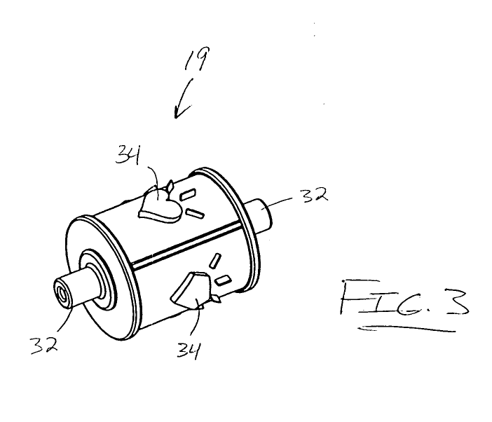

Caster assembly 12 preferably comprises a marker carriage 18 as depicted in FIG. 1, a rotating pen assembly 19 as depicted in FIGS. 1-3, and an overall caster assembly length. The marker carriage 18 preferably comprises a casing attachment member or portion 21, and certain pen assembly-receiving means. The pen assembly-receiving means function to rotatably receive pen assembly 19 and in this regard, may preferably be defined by a bearing structure 22 or similar other bearing means as generally depicted in FIG. 1. When in a fully assembled state as generally depicted in FIG. 3, pen assembly 19 is preferably cylindrical in configuration. In any case, the transverse cross section of pen assembly should preferably be circular or have a closed arc length so that the assembly 19 may roll upon a marking surface.

Pen assembly 19 preferably comprises comprising an inner pen core assembly 23; a plurality of intermediate ink-applying tiles 24; and a marker rotation axis. In this last regard, it is contemplated that although the preferred pen assembly 19 is cylindrical in overall configuration, although conceivably an alternative configuration for the pen assembly may be spherical. The contemplated spherical pen assembly (similar to that of a typical ball point) would necessarily be rotatably received in a socket type assembly-receiving means as formed with the marker carriage. However, rather than being limited to a single marker rotation axis, a spherical pen assembly could conceivably comprise an infinite number of rotation axes depending on the user's directed manual traceability as well as the interaction(s) between the pen assembly and the marking surface.

The inner pen core assembly 23 preferably comprises certain journaling means for cooperating with the bearing means of the carriage 18. The journaling means may be defined in part, by certain core journal end caps 32. It will thus be understood that the pen assembly-receiving means comprises certain bearing means and the pen assembly comprises certain journaling means, the bearing and journaling means being cooperatively associated with one another for enabling rotation about the marker rotation axis.

The rotating pen assembly 19 is the rotatably received by the marker carriage 18 via the pen assembly-receiving means and thus, the pen assembly 19 is rotatable about the marker rotation axis. The caster assembly 12 is preferably rotatably attached to the casing 11 and thus, is rotatable about the casing axis. The ink-applying tiles 24 are received or otherwise attached to the inner pen core assembly 23. The ink-applying tiles 24 further comprise raised patterns 34.

As the raised patterns 34 are engaged against a marking surface after having been placed into contact with an ink pad or similar other ink source, the ink (or a similar other marking medium, such as paint, dye, lead, chalk, wax, oil, acid, bleach, and the like) is thus applied to the marking surface via the ink-applying tiles 24 leaving behind certain patterns as defined by the raised patterns 34. It will be recalled that pen assembly 19 is rotatable and with every complete revolution of at least 360 rotational degrees, a serial pattern is presented. Thus, the rolling marker assembly 10 enables a user to mark serially-presented, repeating patterns upon the marking surface.

The rolling marker assembly 10 may further preferably comprise certain means for guiding the rolling marker assembly or certain marker-guiding means for enabling the user to more effectively trace the caster assembly along the marking surface as the user may elect. In this regard, it is contemplated that a dual caster assembly may function to enable the user to mark either linear patterns or non-linear patterns as the user may elect. The marker-guiding means may preferably be defined by a guide wheel assembly 39 as generally illustrated and referenced in FIG. 1. Guide wheel assembly 39 preferably comprises a swivel type guide frame 40 and a guide wheel 41.

Guide frame 40 is attached to rolling marker assembly 10 intermediate casing 11 and caster assembly 12 via a first frame end. Preferably, the first frame end is rotatably attached to caster assembly 12 such that guide frame 40 may freely rotate about casing axis. Guide wheel 41 is rotatably received by a second frame end for positioned placement adjacent the pen assembly 19. It is contemplated that guide wheel 41 may comprise a diameter either smaller in magnitude than the diameter of pen assembly 19 as generally depicted. Guide wheel 41 is also manually traceable adjacent the marking surface for guiding rolling marker assembly 10.

While the above description contains much specificity, this specificity should not be construed as limitations on the scope of the invention, but rather as an exemplification of the invention. For example, as is described hereinabove, it is contemplated that the present invention essentially discloses a rolling marker assembly for enabling a user to mark serially-presented, repeating patterns upon a marking surface. The rolling marker assembly comprises a hand-holdable casing and caster assembly.

The casing comprises an inner casing surface, an outer casing surface, a substantially circular transverse casing cross-section, and a longitudinal casing axis. The caster assembly comprises a marker carriage and a rotating pen assembly. The marker carriage comprises a casing attachment member and certain pen assembly-receiving means. The pen assembly comprises an inner pen core, a plurality of ink-applying tiles, and a marker rotation axis. Each ink-applying tile is adapted for receiving and applying ink.

The rotating pen assembly is rotatably received by the marker carriage via the pen assembly-receiving means, and the pen assembly is rotatable about the marker rotation axis. The caster assembly is rotatably attached to the casing, and thus is rotatable about the casing axis. Bearing in mind that the ink-applying tiles comprise raised patterns, the casing rim and the outer shell surfaces are manually traceable adjacent a marking surface such that the raised patterns are engageable upon the marking surface for applying ink thereto. The rolling marker assembly thus enables the user to mark serially-presented, repeating patterns upon the marking surface.

Accordingly, although the invention has been described by reference to a preferred embodiment, it is not intended that the novel product, method or kit be limited thereby, but that modifications thereof are intended to be included as falling within the broad scope and spirit of the foregoing disclosure, the following claims and the appended drawings.

I claim:

1. A rolling marker assembly, the rolling marker assembly for enabling a user to mark serially-presented, repeating patterns upon a marking surface, the rolling marker assembly comprising:
a hand-holdable casing and a caster assembly, the casing comprising an inner casing surface, an outer casing surface, a substantially circular transverse casing cross-section, and a longitudinal casing axis, the caster assembly comprising a marker carriage and a rotating pen assembly, the marker carriage comprising a casing attachment member and pen assembly-receiving means, the pen assembly comprising an inner pen core, a plurality of ink-applying tiles, and a marker rotation axis, each ink-applying tile being adapted for receiving and applying ink, the rotating pen assembly being rotatably received by the marker carriage via the pen assembly-receiving means, the pen assembly being rotatable about the marker rotation axis, the caster assembly being rotatably attached to the casing, the caster assembly being rotatable about the casing axis, the ink-applying tiles comprising raised patterns, the casing rim and the outer shell surfaces being manually traceable adjacent a marking surface, the raised patterns being engageable upon the marking surface for applying ink thereto, the rolling marker assembly thus enabling the user to mark serially-presented, repeating patterns upon the marking surface.

2. The rolling marker assembly of claim 1 wherein the pen assembly-receiving means comprises bearing means and the pen assembly comprises journaling means, the bearing and journaling means being cooperatively associated for enabling rotation about the marker rotation axis.

3. The rolling marker assembly of claim 1 wherein the pen assembly is substantially cylindrical in configuration, the pen assembly thus comprising a longitudinal marker rotation axis, the pen assembly being rotatable about the longitudinal marker rotation axis for marking linear, serially-presented, repeating patterns.

4. The rolling marker assembly of claim 3 comprising a marker-guiding means, the marker-guiding means being cooperatively associated with the caster assembly for guiding the rolling marker assembly, the marker-guiding means enabling the user to mark non-linear, serially-presented, repeating patterns.

5. The rolling marker assembly of claim 4 wherein the marker-guiding means are defined by a guide wheel assembly, the guide wheel assembly comprising a guide frame and a guide wheel, the guide frame being attached to the rolling marker assembly intermediate the casing and the caster assembly via a first frame end, the guide wheel being rotatably received by a second frame end for positioned placement adjacent the pen assembly, the guide wheel manually traceable adjacent the marking surface for guiding the rolling marker assembly.

6. The rolling marker assembly of claim 5 wherein the guide frame is rotatably attached to the rolling marker assembly, the guide wheel assembly thus being rotatable about the casing axis.

7. A marker assembly, the marker assembly for marking repeating patterns upon a marking surface, the marker assembly comprising:
a casing and a caster assembly, the casing comprising an inner casing surface, an outer casing surface, and a longitudinal casing axis, the caster assembly comprising a marker carriage and a rotating pen assembly, the marker carriage comprising a casing attachment member and pen assembly-receiving means, a plurality of ink-applying tiles, and a marker rotation axis, each ink-applying tile being adapted for receiving and applying ink, the rotating pen assembly being rotatably received by the marker carriage via the pen assembly-receiving means, the pen assembly being rotatable about the marker rotation axis, the caster assembly being rotatably attached to the casing, the caster assembly being rotatable about the casing axis, the ink-applying tiles comprising raised patterns, the raised patterns being engageable upon a marking surface for applying ink thereto, the marker assembly thus for mark repeating patterns upon the marking surface.

8. The marker assembly of claim 7 wherein the pen assembly-receiving means comprises bearing means and the pen assembly comprises journaling means, the bearing and journaling means being cooperatively associated for enabling rotation.

9. The marker assembly of claim 7 wherein the pen assembly is substantially cylindrical in configuration, the pen assembly thus comprising a longitudinal marker rotation axis, the pen assembly being rotatable about the longitudinal marker rotation axis for marking linear, serially-presented, repeating patterns.

10. The marker assembly of claim 9 comprising marker-guiding means, the marker-guiding means being cooperatively associated with the caster assembly for guiding the marker assembly, the marker-guiding means enabling the user to mark non-linear, serially-presented, repeating patterns.

11. The marker assembly of claim 10 wherein the marker-guiding means are defined by a guide wheel assembly, the guide wheel assembly comprising a guide frame and a guide wheel, the guide frame being attached to the marker assembly intermediate the casing and the caster assembly via a first frame end, the guide wheel being rotatably received by a second frame end for positioned placement adjacent the pen assembly, the guide wheel being manually traceable adjacent the marking surface for guiding the marker assembly.

12. The marker assembly of claim 11 wherein the guide frame is rotatably attached to the marker assembly, the guide wheel assembly thus being rotatable about the casing axis.

13. A marker assembly for marking a surface, the marker assembly comprising:
a casing, the casing comprising an inner casing surface and an outer casing surface; and
a caster assembly rotatably attached to the casing, the caster assembly comprising a marker carriage and a rotating pen assembly, the marker carriage comprising pen assembly-receiving means, a plurality of ink-applying tiles, and a marker rotation axis, each ink-applying tile being adapted for receiving and applying ink, the rotating pen assembly being rotatably received by the marker carriage via the pen assembly-receiving means, the pen assembly being rotatable about the marker rotation axis, the ink-applying tiles comprising raised patterns, the raised patterns being engageable upon a marking surface for applying ink thereto.

14. The marker assembly of claim 13 wherein the pen assembly-receiving means comprises bearing means and the pen assembly comprises journaling means, the bearing and journaling means being cooperatively associated for enabling rotation.

15. The marker assembly of claim 13 wherein the pen assembly is substantially cylindrical in configuration, the pen assembly thus comprising a longitudinal marker rotation axis, the pen assembly being rotatable about the longitudinal marker rotation axis for marking linear, serially-presented, repeating patterns.

16. The marker assembly of claim 13 comprising marker-guiding means, the marker-guiding means being cooperatively associated with the caster assembly for guiding the marker assembly, the marker-guiding means enabling the user to mark non-linear, serially-presented, repeating patterns.

17. The marker assembly of claim 16 wherein the marker-guiding means are defined by a guide wheel assembly, the guide wheel assembly comprising a guide frame and a guide wheel, the guide frame being attached to the marker assembly intermediate the casing and the caster assembly via a first frame end, the guide wheel being rotatably received by a second frame end for positioned placement adjacent the pen assembly, the guide wheel being manually traceable adjacent the marking surface for guiding the marker assembly.

18. The marker assembly of claim 17 wherein the guide frame is rotatably attached to the marker assembly, the guide wheel assembly thus being rotatable about the casing axis.
